(19) United States
(12) Patent Application Publication
(10) Pub. No.: US 2008/0023075 A1
(43) Pub. Date: Jan. 31, 2008

(54) Spill Containment Device

(76) Inventors: Sergio M. Bravo, Commerce, CA (US); Don K. Mukai, Pasadena, CA (US)

Correspondence Address: CHRISTIE, PARKER & HALE, LLP, PO BOX 7068, PASADENA, CA, 91109-7068, US

(21) Appl. No.: 11/829,049

(22) Filed: Jul. 26, 2007

Related U.S. Application Data
(60) Provisional application No. 60/833,643, filed on Jul. 26, 2006.

(51) Int. Cl. B67D 5/60

(52) U.S. Cl. 137/312

(57) ABSTRACT

A spill containment device for a fluid storage tank filling system including a threaded riser pipe extending from a storage tank and a drop tube including a flange at one end with a conduit extending from the flange, through the riser pipe and into the storage tank. The spill containment device includes a tubular base having an inwardly protruding shoulder adapted to receive the flange of the drop tube, lower threads below the shoulder adapted to mate with the threaded riser pipe; and upper threads above the shoulder. A receptacle is attached to the tubular base, the receptacle having an open upper end. A threaded compression ring is provided, the threaded compression ring adapted to mate with the upper threads of the tubular base and attach the drop tube to the tubular base.

### CROSS-REFERENCE TO RELATED APPLICATION(S)

This application claims priority to and the benefit of U.S. Provisional Application No. 60/833,643 filed Jul. 26, 2006, in the U.S. Patent and Trademark Office, the entire content of which is incorporated herein by reference.

### BACKGROUND OF THE INVENTION

The present invention relates to a spill containment device, and more specifically to a spill containment device for preventing ground contamination by liquid fuels and other hazardous fluids.

When underground storage tanks adapted to house large amounts of gasoline or other environmental hazardous liquids underneath retail service stations are being filled, the fluids may be spilled and leak into the ground, potentially causing contamination of ground water and leading to other undesirable consequences. Specifically, spillage most often occurs during connection and disconnection of a fuel hose to a riser pipe leading down to the storage tank.

Various spill containment devices have been developed in attempts to contain spilled liquids and vapors produced by such liquids. However, existing spill containment devices have been prone to leakage, thereby defeating the purpose of the device. Particularly, such spill containment devices often rely on mechanical seals, such as gasket seals and penetration fittings that rely heavily on hose clamps and fasteners, which are more susceptible to leaks than, for example, threaded pipe connections. Additionally, some existing devices incorporate flexible bellows for installation adjustability. However, the bellows are susceptible to physical and chemical stress cracking and may have to be replaced often.

### SUMMARY OF THE INVENTION

In one exemplary embodiment of the present invention, a spill containment device is provided for a fluid storage tank filling system including a riser pipe extending from a storage tank and a drop tube extending into the storage tank coaxial with the riser pipe. The spill containment device includes a tubular base having an inwardly protruding shoulder adapted to receive the drop tube, the drop tube having a flange at one end and a conduit extending from the flange. The tubular base further includes lower threads below the shoulder adapted to attach the base to the riser pipe and upper threads above the shoulder adapted to receive a compression ring. A receptacle is attached to the base, the receptacle having an open upper end. A compression ring is attachable to the base to attach the drop tube to the base. The spill containment may further include a drain hole above the upper threads.

In another exemplary embodiment, a fitting is provided for attaching a spill containment device to a threaded riser pipe of a fluid storage tank filling system including a drop tube comprising a flange at one end with a conduit extending from the flange into the storage tank coaxial with the riser pipe. The fitting includes a tubular base having an inwardly protruding shoulder adapted to receive the flange of the drop tube, lower threads below the shoulder adapted to mate with the threaded riser pipe, upper threads above the shoulder, and a drain hole above the compression ring threads. A threaded compression ring is provided, the threaded compression ring adapted to mate with the upper threads of the tubular base.

### BRIEF DESCRIPTION OF THE DRAWINGS

FIG. 1 is a schematic view of an exemplary spill containment device of the present invention connected to a storage tank by a riser pipe.

FIG. 2 is a cross-sectional view of an exemplary spill containment device of the present invention.

FIG. 3a is a cross-sectional view of an exemplary embodiment of a receptacle and a base of the present invention.

FIG. 3b is a cross-sectional view of an exemplary embodiment of a double-wall receptacle of the present invention.

FIGS. 4a and 4b are a cross-sectional view and a top view, respectively, of the base of FIG. 3a or 3b.

FIGS. 5a and 5b are a top view and a side view, respectively, of an exemplary compression ring of the present invention.

FIG. 6 is a cross-sectional view of an exemplary skirt of the present invention.

FIG. 7a is a cross-sectional view of a drain valve according to an exemplary embodiment of the present invention.

FIG. 7b is a side view of an exemplary rod of the drain valve of FIG. 7a.

FIG. 8 is a schematic view of an exemplary spill containment device of the present invention for a remote fill location.

FIG. 9 is a cross-sectional view of an exemplary tee connector assembly of the present invention.

FIG. 10 is a cross-sectional view of a receptacle including water mitigation devices according to other embodiments of the invention.

### DETAILED DESCRIPTION OF THE INVENTION

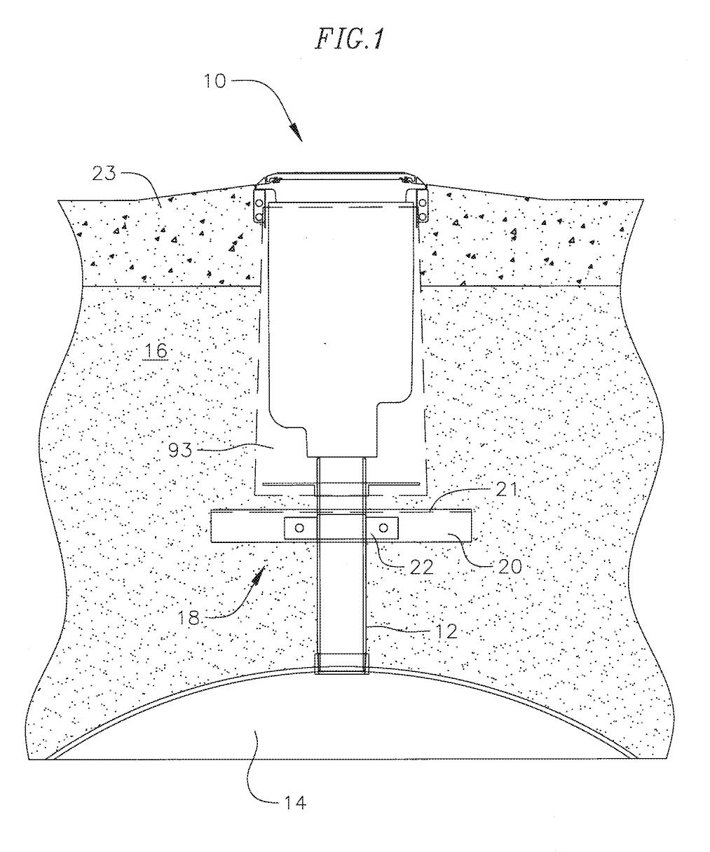

With reference to FIG. 1, a spill containment device 10 is mounted to a riser pipe 12 extending from a storage tank 14. Generally, the storage tank 14 is disposed in an excavation and covered with soil. A layer of pea gravel 16 may be filled over the soil in the excavation and a concrete apron 23 may be poured over the gravel 16 to define a space. The spill containment device 10 may be disposed into a space provided by the skirt 93 so as to be surrounded by the concrete apron 23 and pea gravel 16 such that an interior of the spill containment device is accessible from above.

An anti-rotation anchor 18 may be attached to the riser pipe 12 to prevent the unintended rotation of the riser pipe during removal or installation of the spill containment device 10 onto the riser pipe. In one exemplary embodiment, the rotation anchor may comprise a plate 20 attached to the riser pipe 12 by a bracket 22, the plate providing resistance to the torsional forces applied during removal or installation of the spill containment device 10 when covered with soil or gravel. The plate 20 may include a lip 21 (FIG. 1), or other reinforcement means, to provide increased structural integrity to the plate. Other anti-rotation anchors as known in the art may also be used in connection with the spill containment device 10.

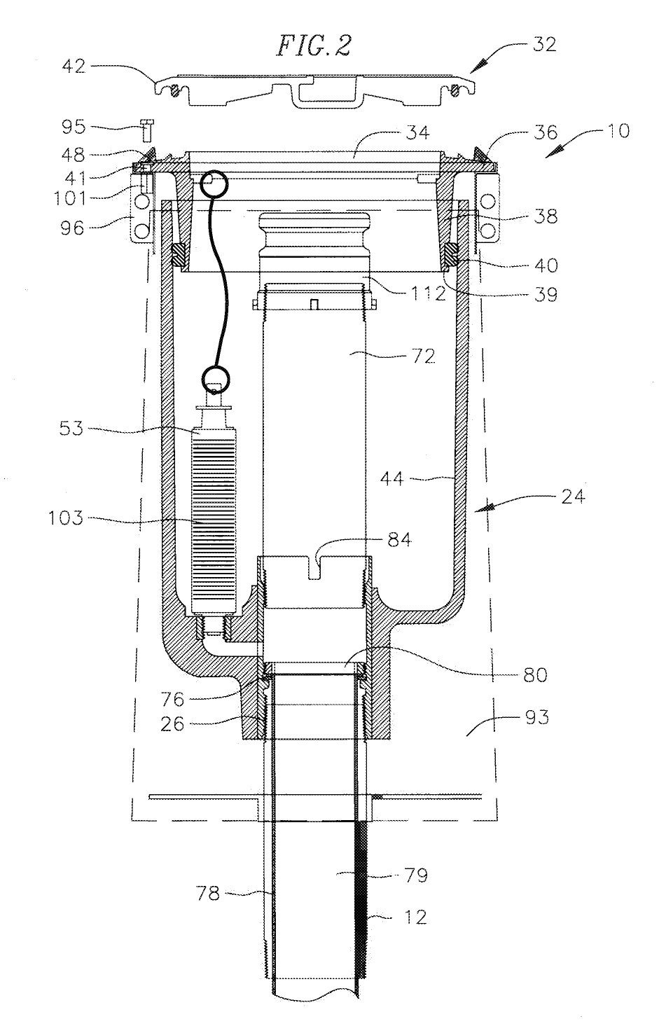

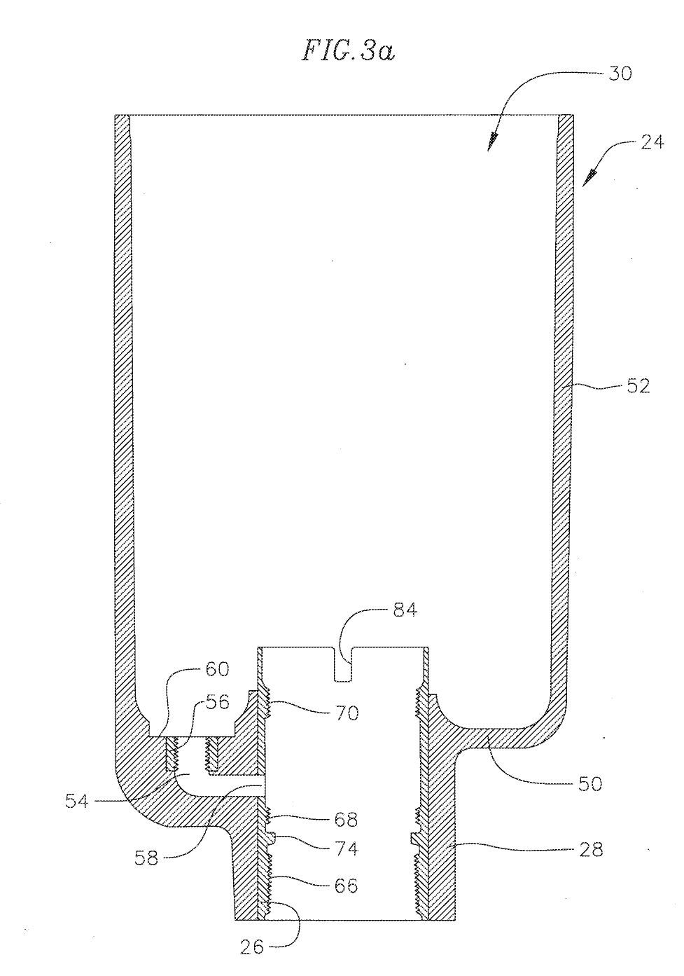

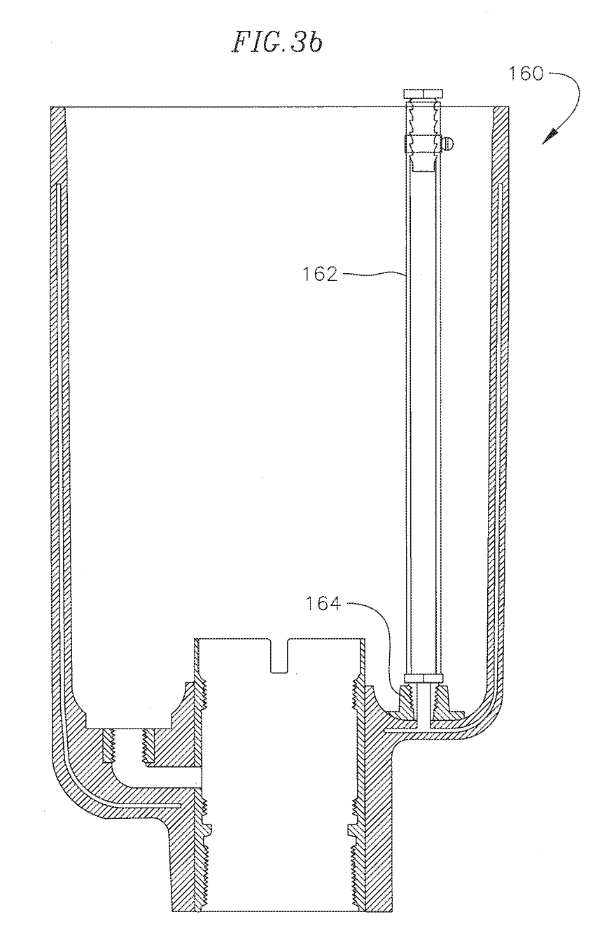

With reference also to FIGS. 2 and 3, in one exemplary embodiment, the spill containment device 10 includes a receptacle 24 having an open upper end 30 which may be sealed by a cover 32. The cover 32 comprises a body 34 with a rim 36 having a sleeve 38 extending therefrom. In one exemplary embodiment, the sleeve 38 may be tapered to reduce the likelihood that the more rigid and heavy sleeve will contact, and therefore potentially damage, the more fragile receptacle 24. The sleeve 38 also helps to protect the wall of the receptacle 24 from being damaged when fill hoses are connected and disconnected to and from the fill line. A seal groove 39 may be located on the sleeve to house a seal 40, the seal 40 adapted to contact an inner surface 44 of the receptacle 24 when the body 34 covers the receptacle 24. In one exemplary embodiment, the seal 40 may be a double O-ring housed in the seal groove 39, but may also be, for example, a single O-ring. By using a sleeve 38 arranged to the receptacle 24 in a telescoping arrangement, minor adjustments in the level of the cover 32 will be at ground level for a completed installation.

An upper periphery of the rim 36 which protrudes above a surface of the concrete apron 23 (FIG. 1) may include a plurality of spaced wedges 48 which deflect, for example, the blade of a snow plow so that the snow plow does not pry the cover 32 from its resting position. The wedges 48 are spaced to allow water that may accumulate on the body 34 to drain. A removable cover plate 42 provides easy access to the receptacle and may be attached over the body 34 to provide a top surface relatively level to the ground. The body 34 may be made of a material such as cast iron and may be finished with zinc plating.

As shown in FIGS. 2 and 6, a skirt 93 may be attached to the cover 32 by, for example, bolts 95. The skirt 93 includes a skirt body 94 and at least one skirt attachment ear 96. The skirt attachment ear 96 includes at least one bolt hole 101 adapted to be aligned with a cover bolt hole 41. A bolt 95 is fastened through the coupling nut 101, 41 to attach the skirt 93 to the body 34 of the cover 32. The skirt body 94 may taper outwardly from the attachment portion 96 and, in one exemplary embodiment, extends past a lower end of a base 26 of the spill containment device 10. The skirt surrounds the receptacle 24 and prevents gravel and other debris from contacting the receptacle and interfering with its operation. In one exemplary embodiment, the skirt is made from steel.

With reference now to FIGS. 2, 3a and 3b, the receptacle 24 includes a bottom wall 50 and a side wall 52 which define a space to contain fluid. The bottom wall 50 has a generally U-shaped cross-section providing a channel for fluid flow toward a drain valve 53 (FIG. 2) at a medial side of the bottom wall abutting the base 26. The thickness of the bottom wall 50 and the side wall 52 may be generally uniform. However, a portion of the bottom wall 50 may be expanded to include a drain conduit 54 having a drain valve coupling 56 at one end and a drain hole 58 at another end. Additionally, a bottom wall surface section 60 may be recessed from the bottom wall 50 adjacent the drain valve coupling 56 to form a sump to encourage fluid to flow toward the drain valve 53. In one exemplary embodiment, the receptacle 24 may be made from fiberglass. However, the receptacle may also be made from plastic, steel, or any other suitable rigid material. The receptacle 24 may be single-walled or double-walled to provide extra protection against leakage, as is known in the art. Additionally, in the case of a double-walled receptacle 160 as shown in FIG. 3b, a liquid level indicator, such as a manometer 162, may be attached to the receptacle by a manometer coupling 164 to provide an indication of leakage within the spill containment device 10. Additionally, a second riser pipe may be attached to a double-walled receptacle, for example, by a second threaded connection.

A tubular spout 28 extends from the bottom wall 50 of the receptacle 24 and is adapted to be mounted with a base 26. The base 26 may be generally cylindrical and may extend slightly above the topmost portion of the inner bottom wall 50. The base 26 may be attached to or integral with the receptacle 24. In one exemplary embodiment, the base 26 is made from carbon steel with a zinc coating, and the base may be integrally molded with the fiberglass receptacle 24 using methods commonly known in the prior art. In other words, even though the receptacle 24 and the base 26 may be different materials, the spout 28 of the receptacle may be molded to the base such that the receptacle and the base essentially become a single object.

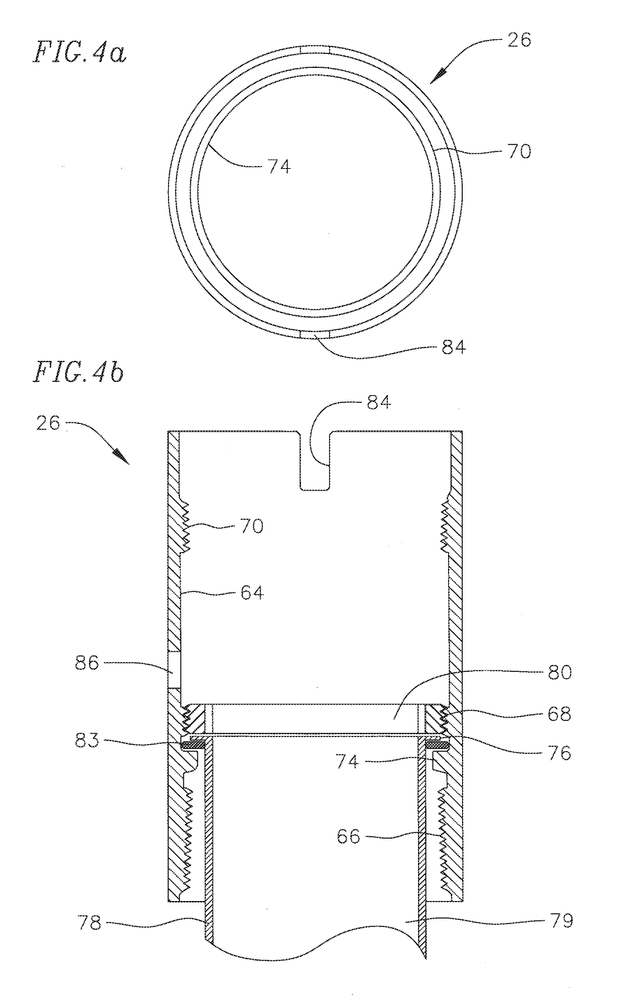

With reference also now to FIGS. 4a and 4b, the base 26 includes a partially threaded inner wall 64, as described in more detail below. A drain hole 86 may penetrate the wall 64 to allow fluid to drain from the drain valve 53 (FIG. 2), as described in more detail below. A top section of the base 26 may include two notches 84 aligned with each other. A tool (not shown) may be inserted into the notches 84 to provide torsional force to secure the spill containment device 10 onto the riser pipe 12. More specifically, the tool may include a bar or plate that may be keyed into the notches 84 to allow force to be applied to the base 26. The notches 84 allow force to be applied directly to the steel base 26 rather than to the more fragile fiberglass receptacle 24, therefore reducing the likelihood of damaging the receptacle. Although a two-notch configuration has been described, one of ordinary skill in the art will appreciate that other configurations may be used without deviating from the spirit and scope of the present invention.

In one exemplary embodiment, the base 26 has three threaded sections to provide connections between components without a need for complicated mechanical seals. In one configuration from bottom to top, the threaded sections include riser pipe threads 66, compression ring threads 68, and nipple threads 70. The riser pipe threads 66, adapted to receive the riser pipe 12 (FIG. 2), and the nipple threads, adapted to receive a nipple 72 (FIG. 2), may be tapered threads (NPT) allowing a seal to be formed between the base 26 and the adjoining components. The compression ring threads 68 may be straight threads (NPTS).

With reference also to FIG. 4b, a shoulder 74 protrudes from the inner wall 64 of the base 26 to provide a resting place for a flange 76 of a drop tube 78, as described in more detail below. In one exemplary embodiment, the shoulder 74 is below the compression ring threads 68 to allow a compression ring 80 to apply a force to the flange 76 of the drop tube 78. The shoulder 74 may extend far enough to provide a stable shelf on which the flange 76 rests, but not extend so far as to interfere with a drop tube conduit 79. In one exemplary embodiment, the shoulder extends about ⅜″ inch from the inner wall 64. Additionally, the base 26 includes a drain hole 86 above the shoulder 74 and aligned with the drain hole 58 of the drain conduit 54 to allow drained fluid to flow into the drop tube 78.

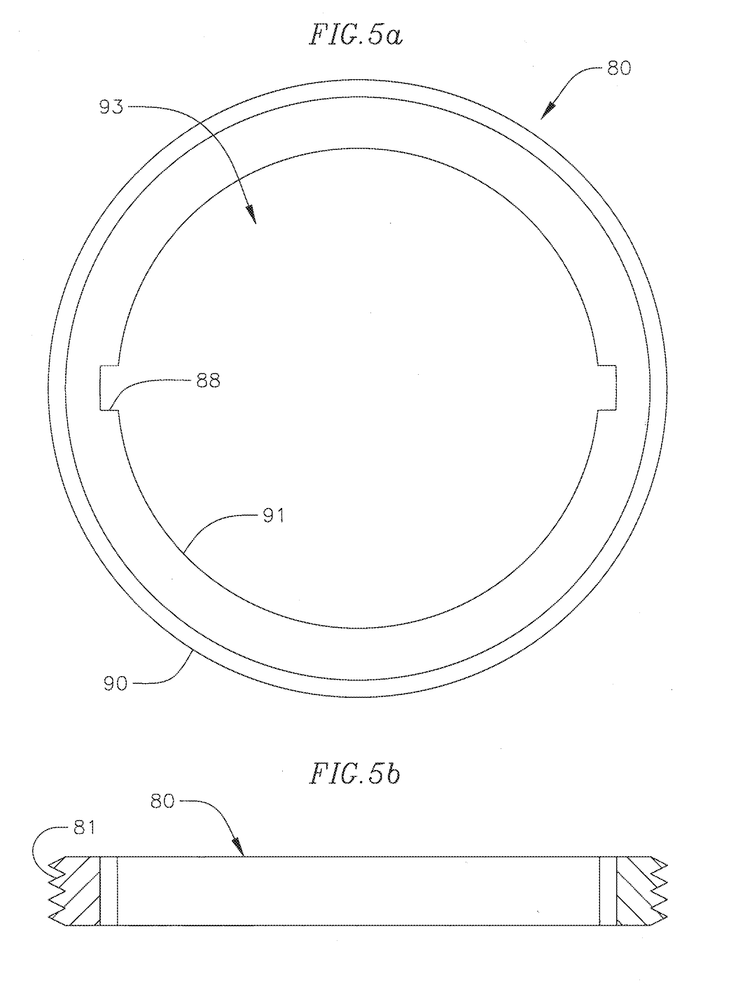

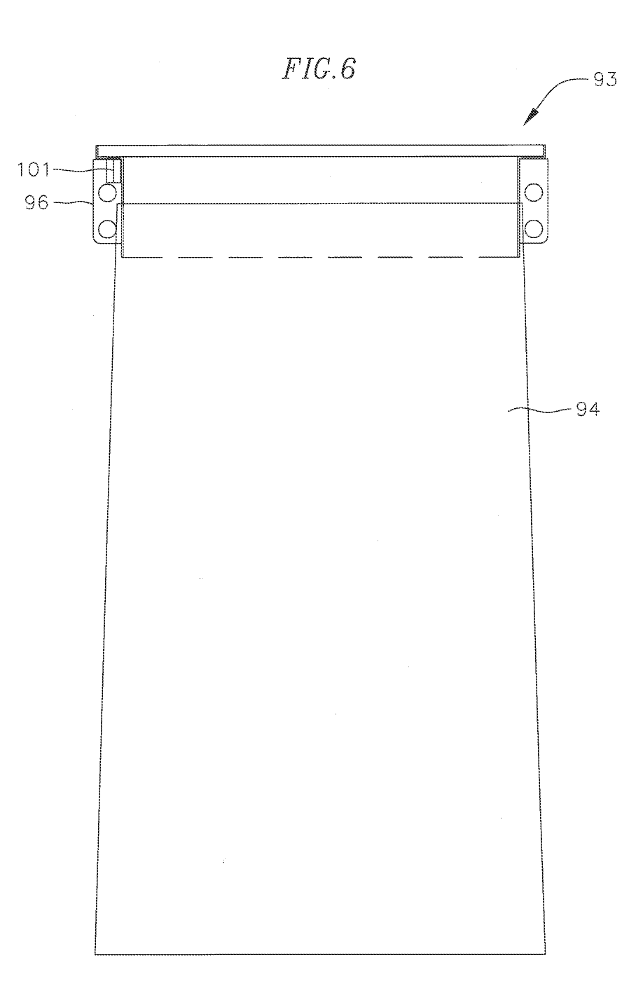

With reference now to FIGS. 5a and 5b, the compression ring 80 has an outer thread 81 on an outer surface 90. In one exemplary embodiment, an inner surface 91 of the compression ring 80 may include two opposite-facing notches 88 adapted to receive a tool (not shown) to tighten the compression ring along the compression ring threads 68 of the base 26 to secure the drop tube flange 76 to the shoulder 74 of the base 26. More specifically, the tool may include a bar or plate that may be keyed into the notches 88 to allow force to be applied to the compression ring 80. The compression ring 80 has a central opening 91 through which fluid may flow into the drop tube 78 (FIG. 4b) when the flange 76 is secured. Although a two-notch configuration has been described, one of ordinary skill in the art will appreciate that other configurations may be used without deviating from the spirit and scope of the present invention. The compression ring 80 may be made from, for example, zinc-coated carbon steel, or any other sufficiently rigid material.

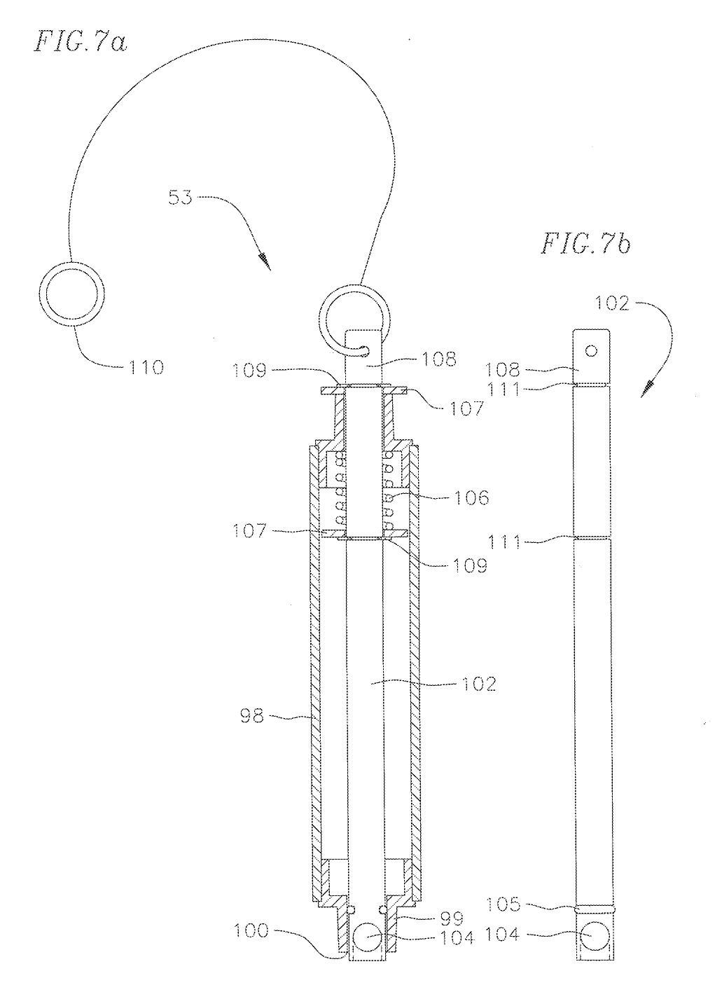

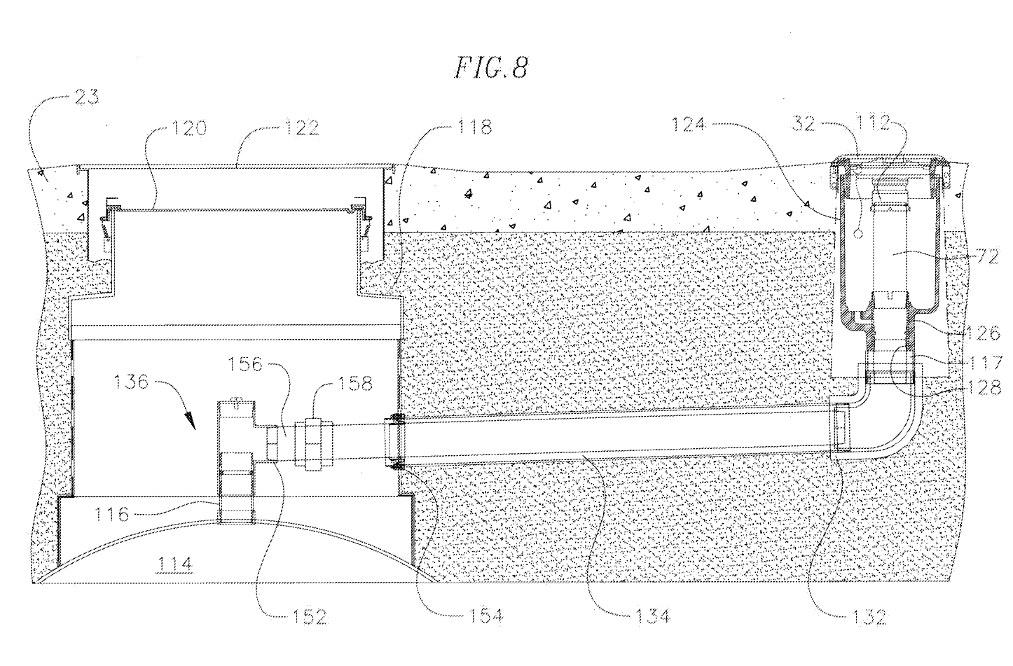

A drain valve 53 is provided, as shown in FIGS. 2 and 7a-7b, to permit fluid collected in the receptacle 24 to drain into the drop tube 78. The drain valve 53 includes a generally cylindrical hollow housing 98 and a lower threaded end 99 adapted to be attached to the threaded drain valve coupling 56 in the bottom wall 50 of the receptacle 24 (FIG. 2). The housing 98 includes slits 103 to allow fluid to penetrate the housing while keeping debris out of the housing. The lower threaded end 99 has a lower end opening 100 which permits fluid to drain into the drain conduit 54 as described in more detail below. With reference now to FIGS. 7a and 7b, a rod 102 is slidably disposed within the housing 98, the rod having a cut-away portion 104 at one end and having an O-ring 105 above the cut-away portion to form a plug to provide a seal against fluid leakage when the drain valve 53 is in a closed position.

One end of the rod 102 extends out of an upper end of the housing 98 and acts as a handle 108. An actuator 110, such as a cord with a ring attached to one end, may be attached to the handle to allow a user to move the rod 102 from the closed position to an open position. In the closed position (FIG. 7a), the cut-away portion 104 is within the lower threaded end 99 and below the bottom wall surface 60 (FIG. 3a) such that the plug prevents fluid from flowing into the drain valve 53. A spring 106 biases the rod 102 toward the threaded lower end 99 to be in the closed position. The spring is contained between a pair of washers 107 which are maintained in place by spring clips 109 that clip onto the rod at clip channels 111. When a force to overcome the spring bias is applied to the handle 108 by, for example, pulling on the actuator 110, the spring compresses to move the plug into an open position in which the cut-away portion 104 is at least partially within the housing 98 above a bottom wall surface 60 (FIG. 3a). In the open position, fluid from the bottom wall surface 60 can drain into the lower threaded end 99 through the cut-away portion 104 from the receptacle 24 into the drain conduit 54 and into the drop tube 78 (FIG. 4b).

The installation and operation of the spill containment device 10 will now be described with reference to FIGS. 1 and 2. As shown in the figures, the riser pipe 12 extends from the storage tank 14 toward the concrete apron 23. The base 26 may then be threaded to the riser pipe 12 using the riser pipe threads 66 to attach the spill containment device 10 to the riser pipe. A tool (not shown) may be used on the notches 84 to securely attach the base 26 to the riser pipe 12. The drop tube 78 may be inserted through the open upper end 30 (FIG. 3a) of the receptacle 24 and through the base 26 such that the drop tube conduit 79 extends into the storage tank 14 and the flange 76 rests on the shoulder 74 of the base 26. In one exemplary embodiment, a gasket 83 (FIG. 4b) may be located between the flange 76 and the shoulder 74 to provide a seal. Additionally, the drop tube 78 may include an overfill protector as is generally known in the art. For example, the overfill protector may be a mechanical valve which closes when the tank reaches about 90% capacity.

With reference to FIGS. 4a-5b, the compression ring 80 may then be used to secure the drop tube 78 to the base 26. More specifically, the threads 81 of the compression ring 80 may be used to thread the compression ring through the nipple threads 70 to pass through an upper portion of the base 26 before being threaded on the compression rings threads 68 to secure the compression ring against the flange 76. A tool may be used in connection with the notches 88 to sufficiently tighten the compression ring 80 against the flange 76.

Once the drop tube 78 has been secured, a nipple 72 (FIG. 2) can be threaded onto the nipple threads 70 (FIG. 3a), and a fill or vapor swivel adaptor 112 can be attached to the nipple 72 to permit connection of an external hose for filling the storage tank. The drain valve 53 may then be threaded to the drain valve coupling 56 (FIG. 3a) using the threaded lower end 99 (FIG. 3a). The threaded connections used between many components of the spill containment mechanism 10 ensure a more reliable seal than when mechanical connections, such as hose clamps, fasteners, gaskets and compression on plastic assemblies, are used between such components.

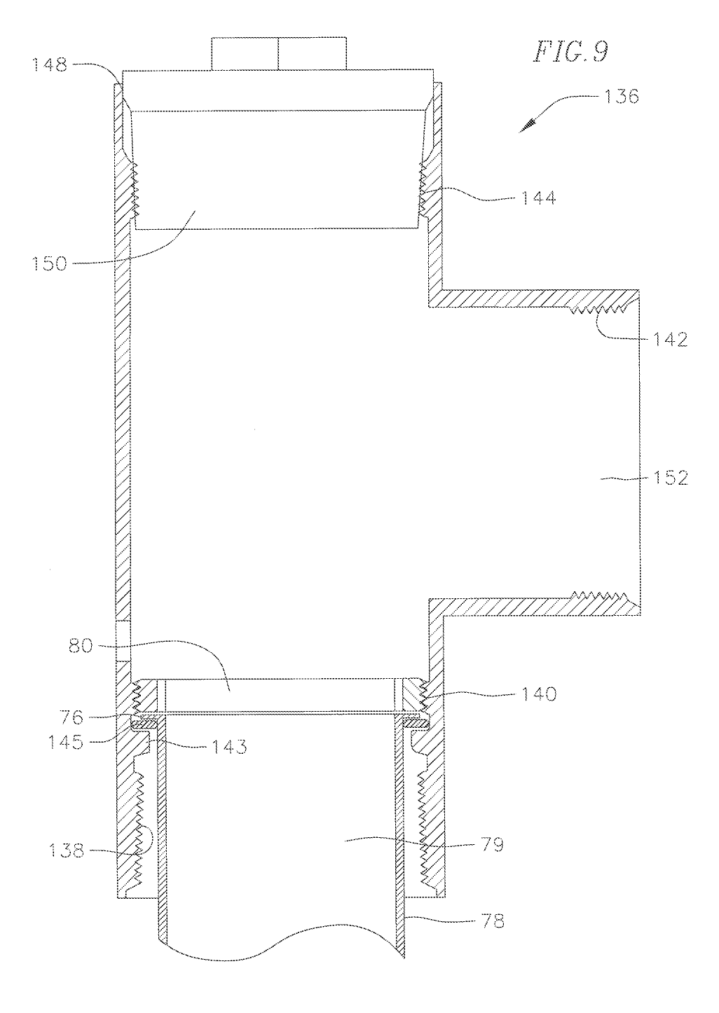

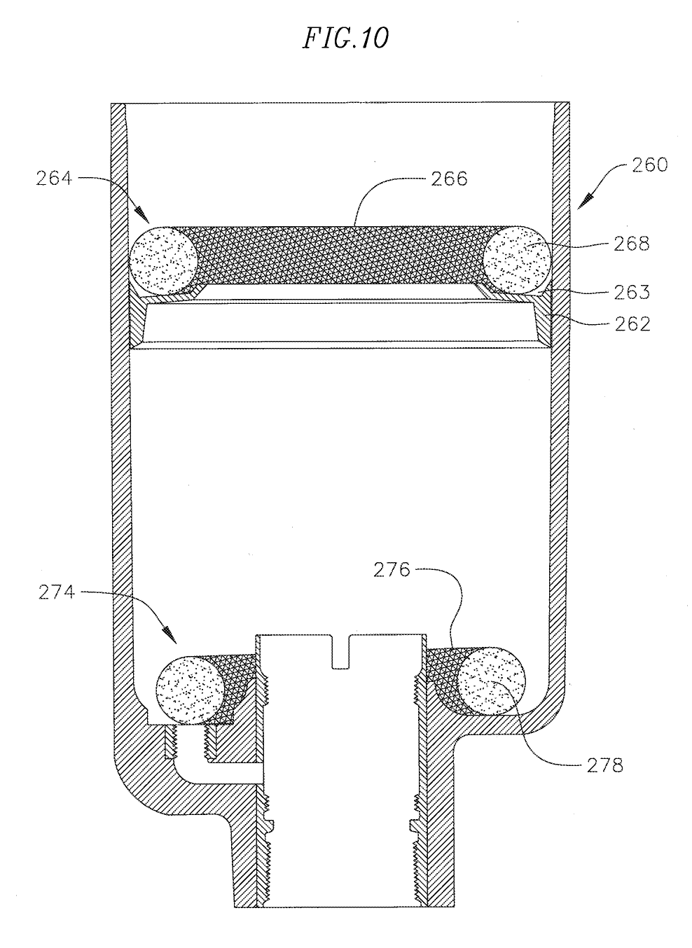

In cases where it is not possible for a tanker truck to access a fill adaptor located directly above a storage tank, a remote fill location may be used as shown in an alternate embodiment of the present invention with reference to FIGS. 8 and 9.

In one exemplary embodiment, a housing 118 is fitted over a storage tank 114 and protrudes toward the concrete apron 23. The housing 118 serves to surround and protect the pipe system from debris or foreign objects from interfering with its operation. Additionally, the housing 118 serves to define a space for access to the storage tank piping system. A removable housing cover 120 may be placed over the housing when access to the storage tank 114 is necessary. The housing may be accessed by removing a manhole cover 122 disposed to cover a hole in the concrete apron 23.

In one exemplary embodiment, a first riser pipe 116 (FIG. 8) is connected to and extends from the storage tank 114. A tee connector 136 is provided to form a secure seal for a pipe system connecting a receptacle 124 to the storage tank 114 and to secure a drop tube 78 (FIG. 9). The tee connector 136 includes riser pipe threads 138, compression ring threads 140, connection pipe threads 142 and plug threads 144 to provide various threaded connections between components. The tapered riser pipe threads 138 and connection pipe threads 142 provide a sealed connection against leakage and eliminate the need for complicated mechanical seals. Additionally, the tee connector 136 includes a shoulder 143 between the riser pipe threads 138 and the compression ring threads 140, similar to the shoulder on the base 26 (FIG. 4b) described above. In one exemplary embodiment, the shoulder 143 extends about ⅜ inch from a surface of the tee connector 136. The tee connector 136 is attachable to the first riser pipe 116 by the riser pipe threads 138. Additionally, the tee connector 136 may include notches to allow a tool to tighten the tee connector to the first riser pipe 116.

Once the tee connector 136 has been secured to the first riser pipe 116, a drop tube 78 may be inserted through the tee connector 136 such that a drop tube conduit 79 extends into the storage tank 114 and a flange 76 of the drop tube 78 rests on the shoulder 143. A gasket 145 may be located between the shoulder 143 and the flange 76 to provide a seal. A compression ring 80 may be inserted through an upper opening 148 of the tee connector 136, threaded through plug threads 144, and then threaded onto the compression ring threads 140 to secure the drop tube 78 to the tee connector 136.

A plug 150 is provided to seal the upper opening 148 to prevent debris, water, or other contaminants from entering the tee connector and potentially contaminating the storage tank contents. The plug 150 may be threaded to the tee connector 136 on the plug threads 144 or may be attached by interference fit.

As shown in FIG. 8, a pipe system may be implemented which allows access to the storage tank from the remote fill location. Similarly to the previously described embodiments, a receptacle 124 may be located within the concrete apron 23 providing access for an external pipeline to deliver contents to the storage tank 114. Specifically, when the cover 32 is lifted from the receptacle, the external pipeline can be connected to a swivel adapter 112 on a nipple 72, as described above, to connect the external pipeline to the storage tank 114.

The receptacle 124 may include a base 126 similar to the base 26 (FIG. 4b). The base 126 includes riser pipe threads 128 adapted to be connected to a second riser pipe 117. The secondary riser pipe 117 may be connected to a connection pipe 134 by an elbow 132 and the connection pipe 134 may be connected to a side opening 152 of the tee connector 136 to provide a conduit from the remote fill location to the storage tank 114. A penetration fitting 154 as is generally known in the art may be used to seal an opening where the connection pipe 134 enters the housing 118. Additionally, a union 158 as is commonly know in the art may be used to connect a nipple 156 attached to the tee connector and the connection piper 134 to allow easier access to the first riser pipe 116 and storage tank 114 without having to disassemble the entire pipe assembly. More specifically, the union 158 may be disengaged to allow the tee connector 136 to be unthreaded from the first riser pipe 116.

Turning to FIG. 10, a spill containment receptacle 260 is illustrated that includes water mitigation devices according to still other embodiments of the invention. The receptacle of this embodiment includes an upper interior shelf 262 defining a trough 263 for collecting water that may enter the receptacle such as from rainfall or from washing the driveway surface above the receptacle. A flexible, water-absorbent sock 264 is seated in the trough 263 to absorb water that collects in the trough 263.

According to an embodiment, the water-absorbent sock 264 is a fabric sleeve 266 filled with an absorbent material 268 such as polyacrylate in bead or granular form. In a variation on this embodiment, the absorbent material 268 absorbs water, but repels hydrocarbons. The fabric of the sleeve 266 is a durable material such as canvas that is resistant to hydrocarbons. The water-absorbent sock 264 may be a ring-shaped tube that is placed in the trough 263, or a cylindrical tube that is coiled into the trough 263. In one embodiment, the water-absorbent sock 264 is designed to be reusable. According to this embodiment, any absorbed water may be wrung from it once it has been loaded with water. In another embodiment, the sock is disposable, and can be replaced once loaded with water.

According to yet another embodiment, also shown in FIG. 10, a second water-absorbent sock 276 is placed at the bottom of the receptacle 260. As with the previous water-absorbent sock, 266, it includes a fabric sleeve 276 filled with an absorbent material 278. Where the receptacle includes a drain valve, the water absorbent sock 276 may be provided as a cylindrical tube that can be coiled at the bottom of the receptacle to avoid interfering with the drain valve. While two water-absorbent socks are illustrated, it should be apparent not all applications would require both, and in certain applications, just one or the other may be used.

Such water mitigation devices help to prevent water and hydrocarbon from mixing at the bottom of the receptacle where they might be drained into the underground tank. This is important because many gasoline blends presently contain an alcohol such as ethanol which is highly soluble in water. If any significant amount of water enters the storage tank, it tends to attract the alcohol and cause it to separate from the hydrocarbons in the gasoline. Without the desired amount of alcohol, the environmental benefits desired by the inclusion of such an alcohol in the gasoline are lost. Furthermore, alcohols tend to be high octane ingredients in gasoline such that the loss of any significant portion of the alcohol from the gasoline blend could result in a reduction in the octane rating of the gasoline. A reduction in octane rating could be harmful to motor vehicle engines designed to run on fuels with minimum octane ratings.

Although exemplary embodiments of the present invention have been shown and described, it will be appreciated by one of ordinary skill in the art that various modifications may be made without departing from the scope and spirit of the invention as defined in the claims below.

What is claimed is:

1. A spill containment device for a fluid storage tank filling system including a threaded riser pipe extending from a storage tank and a drop tube including a flange at one end with a conduit extending from the flange, through the riser pipe and into the storage tank, the spill containment device comprising:
a tubular base comprising:
an inwardly protruding shoulder adapted to receive the flange of the drop tube;
lower threads below the shoulder adapted to mate with the threaded riser pipe; and
upper threads above the shoulder;
a receptacle attached to the tubular base, the receptacle having an open upper end; and
a threaded compression ring adapted to mate with the upper threads of the tubular base and attach the drop tube to the tubular base.

2. The spill containment device of claim 1, further comprising a drain conduit in the receptacle allowing communication between a low point in the receptacle and a drain hole above the upper threads of the tubular base.

3. The spill containment device of claim 2, further comprising a drain valve at the drain conduit of the receptacle comprising:
a housing defining an inlet in communication with an interior of the receptacle and an outlet in communication with the drain conduit of the receptacle;
a plug disposed within the housing between a closed position in which the plug blocks communication between the inlet and the outlet of the housing, and an open position in which the plug permits communication between the inlet and the outlet of the housing;
a rod extending through the housing and adapted to move the plug between the open and closed positions; and
a spring biasing the plug in the closed position.

4. The spill containment device of claim 1, further comprising: a cover defining a sleeve extending into the receptacle; and a seal adapted to seal the sleeve to an inner wall of the receptacle.

5. The spill containment device of claim 6, wherein the seal is a double O-ring.

6. The spill containment device of claim 4, further comprising a skirt attached to the cover, and extending downwardly around the receptacle past the tubular base.

7. The spill containment device of claim 1, wherein the tubular base is integrally molded to the receptacle.

8. The spill containment device of claim 1, wherein the tubular base further comprises at least one notch adapted to receive a tool for tightening the tubular base to the riser pipe.

9. The spill containment device of claim 1, wherein the compression ring further comprises at least one notch adapted to receive a tool for tightening the compression ring against the flange of the drop tube.

10. The spill containment device of claim 1 wherein the receptacle is a double-walled receptacle.

11. The spill containment device of claim 10 wherein a second riser pipe is connected to the double-walled receptacle.

12. The spill containment device of claim 1 further comprising a gasket between the flange of the drop tube and the shoulder of the tubular base.

13. A fitting for attaching a spill containment device to a threaded riser pipe of a fluid storage tank filling system including a drop tube comprising a flange at one end with a conduit extending from the flange into the storage tank coaxial with the riser pipe, the fitting comprising:
a tubular base comprising:
an inwardly protruding shoulder adapted to receive the flange of the drop tube;
lower threads below the shoulder adapted to mate with the threaded riser pipe;
upper threads above the shoulder; and
a drain hole above the compression ring threads; and
a threaded compression ring adapted to mate with the upper threads of the tubular base.

14. The fitting of claim 13, further comprising at least one notch adapted to receive a tool for tightening the tubular base to the riser pipe.

15. The fitting of claim 13, further comprising nipple threads above the upper threads adapted to receive a threaded nipple adapted to extend up from the fitting.

16. The fitting of claim 15, wherein the nipple threads are contiguous with the upper threads.

17. The fitting of claim 13, further comprising a plug for sealing an open upper end of the fitting.

18. The fitting of claim 17, wherein the fitting is a tee fitting.

19. A spill containment device comprising the fitting of claim 13 and a receptacle.

20. The spill containment device of claim 13 wherein the receptacle is a double-walled receptacle.

21. A spill containment device for a fluid storage tank filling system including a threaded riser pipe extending from a storage tank and a drop tube including a flange at one end with a conduit extending from the flange, through the riser pipe and into the storage tank, the spill containment device comprising:
a tubular base comprising:
an inwardly protruding shoulder adapted to receive the flange of the drop tube;
lower threads below the shoulder adapted to mate with the threaded riser pipe;
upper threads above the shoulder; and
a drain hole extending through a wall of the tubular base above the upper threads
a receptacle attached to the tubular base, the receptacle having an open upper end and defining a sump including a drain conduit communicating with the drain hole of the tubular base;
a gasket between the flange of the drop tube and the shoulder of the tubular base; and
a threaded compression ring adapted to mate with the upper threads of the base and press the flange of the drop tube to the gasket in order to form a seal between the flange of the drop tube and the shoulder of the tubular base.

22. A water mitigation device comprising a fabric sleeve filled with a water-absorbent material.
